(19) United States
(12) Patent Application Publication
(10) Pub. No.: US 2002/0055429 A1
(43) Pub. Date: May 9, 2002

(54) Carton blank and carton formed therefrom

(76) Inventor: Joseph C. Walsh, Boulder, CO (US)

Correspondence Address: Michael A. Goodwin, Esq., Klaas, Law, O'Meara & Malkin, P.C., Suite 2225, 1999 Broadway, Denver, CO, 80202, US

(21) Appl. No.: 10/027,744

(22) Filed: Dec. 20, 2001

Related U.S. Application Data
(63) Continuation of application No. 09/220,065, filed on Dec. 23, 1998.
Application No. 09/220,065 is a continuation-in-part of application No. 09/017,108, filed on Jan. 31, 1998, now abandoned.
Application No. 09/017,108 is a continuation-in-part of application No. 08/934,269, filed on Sep. 19, 1997.

(51) Int. Cl. B31B 1/25

(52) U.S. Cl. 493/59

(57) ABSTRACT

A carton blank and a carton formed therefrom wherein the formed carton is fluid impervious and is provided with a pour spout but retains the fluid imperviousness of the carton until the pour spout is opened and wherein the pour spout has wing portions located between an inner and an outer layer of the carton and free to move relative thereto.

This application is a continuation of U.S. patent application Ser. No. 09/220,065 filed Dec. 23, 1998, for Carton Blank and Carton Formed Therefrom of Joseph C. Walsh which is a continuation-in-part of U.S. patent application Ser. No. 09/017,108 filed Jan. 31, 1998, for Carton Blank And Carton Formed Therefrom of Joseph C. Walsh (now abandoned) which application is a continuation-in-part of U.S. patent application Ser. No. 08/934,269 filed Sep. 19,1997, for Carton Blank and Carton Formed Therefrom of Joseph C. Walsh (now U.S. Pat. No. 5,857,614), all of which are hereby specifically incorporated by reference for all that is disclosed therein.

### FIELD OF THE INVENTION

This invention is directed generally to a carton blank and carton formed therefrom and more particularly to a leakproof carton from which the materials contained therein may be readily removed.

### BACKGROUND OF THE INVENTION

There are many kinds of leakproof cartons on the market. The vast majority of these cartons have an outer layer formed from a relatively rigid material for protection and an inner layer formed from a relatively flexible material for providing the leakproof qualities. When it is desired to remove the material in the carton, it is necessary to first open the outer layer, and then open the inner layer. Also, the inner layer generally is not secured to the outer layer so access to the inner layer sometimes presents a problem. This is particularly true in leakproof cartons that are designed to hold only one serving. Another problem relates to the formation of a pour spout in such cartons.

### BRIEF DESCRIPTION OF THE INVENTION

This invention provides a leakproof carton comprising an outer layer formed from a relatively rigid material and an inner layer formed from a relatively flexible fluid impervious material which carton is readily opened in one simultaneous operation so that the material therein may be readily removed. Also, the parts of the outer and inner layer adjacent to the opening remain secured together to facilitate further the removal of the material contained therein. The invention also provides a carton blank from which the carton is formed.

The invention also provides a carton blank and a carton formed therefrom which carton is fluid impervious and is provided with a pour spout so that the carton retains its fluid imperviousness until the pour spout is opened.

In a preferred embodiment of the invention, the carton blank comprises a unitary sheet of a relatively rigid material having an inner surface and an outer surface, a left side edge, a right side edge, a top edge and a bottom edge. The unitary sheet of a relatively rigid material has a length extending from the top edge to the bottom edge and a width extending from the left side edge to the right side edge. The unitary sheet of relatively rigid material has a plurality of cut and fold lines for dividing the unitary sheet of a relatively rigid material in a conventional manner into a plurality of panels including into a back wall panel, a front wall panel, opposite sidewall panels, a glue tab panel and top and bottom panels extending outwardly in opposite directions from the front wall, back wall and opposite sidewall panels. The glue tab panel has a top edge and a bottom edge. The carton blank also comprises a generally rectangular sheet of a relatively flexible fluid impervious material having an inner surface and an outer surface, a central body portion, a top body portion, a bottom body portion, a left side edge, a right side edge and top and bottom edges. The central body portion of the rectangular sheet of a relatively flexible fluid impervious material is secured to opposite portions of the unitary sheet of a relatively rigid material. Linearly extending weakened portions are formed in at least portions of the unitary sheet of a relatively rigid material that is secured to the central body portion. At least portions of the generally rectangular sheet of a relatively flexible fluid impervious material are easily separated along a line opposite to the linearly extending opening means. The at least portions are joined together by adhesive to preserve the integrity of the generally rectangular sheet of a relatively flexible fluid impervious material but to permit the separation thereof.

In a preferred embodiment of the invention, the relatively flexible fluid impervious material comprises a plastic material. The generally rectangular sheet of a plastic material comprises a separate first portion and a separate second portion with at least portions of one of the separate first and second portions overlying at least portions of the other of the first and second portions. A continuous portion of the first portion is secured to a continuous portion of the second portion to preserve the integrity of the generally rectangular sheet of a plastic material. At least a portion of the continuous portions is located opposite to the linearly extending weakened portions to permit the separation of the first and second portions simultaneously with the outer layer.

In another preferred embodiment of the invention, the rectangular sheet of a relatively flexible fluid impervious material comprises a laminate of a paper material and a plastic material with the paper material being secured to opposite portions of the unitary sheet of a relatively rigid material. The generally rectangular sheet of a relatively flexible fluid impervious material comprises a separate first portion and a separate second portion. Each of the separate first and second portions has an edge portion with the edge portions being in a face to face relationship and located opposite to the linearly extending opening means. At least all of the edge portions of the paper portions are secured together to preserve the integrity of the generally rectangular sheet of a relatively flexible fluid impervious material but to permit separation of the first and second portions simultaneously with the outer layer.

In another preferred embodiment of the invention, the generally rectangular sheet of a relatively flexible fluid impervious material comprises a laminate of a generally rectangular sheet of a relatively flexible paper material and a plastic material wherein the plastic material comprises a separate first portion and a separate second portion. At least portions of one of the separate first and second portions overlies at least portions of the other of the separate first and second portions. A continuous portion of the first portion is secured to a continuous portion of the second portion to preserve the integrity of the generally rectangular sheet of a relatively flexible fluid impervious material. At least a portion of the continuous portions is located opposite to the linearly extending weakened portions to permit the separation of the first and second portions simultaneously with the outer layer.

In another preferred embodiment of the invention, the conventional panel portions have a front wall panel, a back wall panel and at least one sidewall panel portion having opposite side edges. The front and back wall panels are integral with one of the opposite side edges and are joined to the at least one sidewall panel portion by a fold line. The linearly extending weakened portions of the outer layer extend from a location in one of the front and back wall panels to a location in the other of the front and back wall panels.

In another preferred embodiment of the invention, the carton formed from the carton blank is provided with a pour spout. One of the sidewall panels has opposite substantially parallel side edges formed by a portion of the fold lines. Linearly extending weakened portions, similar to those described above, have at least one portion extending between the opposite side edges and terminate in opposite ends. The opposite side edges are formed as linearly extending weakened portions extending from the opposite ends. Spout forming material is provided and has a central portion and two wing portions integral with the central portion and extending outwardly on either side thereof. At least a portion of the central portion is secured to at least a portion of the central body portion of the generally rectangular sheet secured to opposite portions of the opposite side edges.

A carton formed from the above described carton blanks comprises an outer layer formed from the relatively rigid material and having linearly extending weakened portions formed in at least parts thereof and an inner layer formed from the relatively flexible fluid impervious material and having a central body portion secured to opposite portions of the outer layer. The central body portion has a weakened portion along a line opposite to the linearly extending weakened portions so that one opening can be simultaneously formed in the outer and inner layers.

In all of the above cartons, the outer and inner layers are in a sealed together relationship in the areas adjacent to the opening.

In another preferred embodiment of the invention, the carton blank comprises an outer layer comprising a generally rectangular sheet of a relatively rigid material and having a plurality of cut and fold lines formed therein for dividing the outer layer into conventional panels. At least one top panel is integral with at least a first sidewall panel and is joined thereto by a fold line. The at least a first sidewall panel is integral with a second sidewall panel and a third sidewall panel and is joined thereto by opposite fold lines. A first weakened portion is formed in the at least sidewall panel adjacent to the fold line between the at least one top panel and the at least a first sidewall panel. A fold line is formed in the at least a first sidewall panel extending between the opposite fold lines and spaced from the first weakened portion. A second weakened portion is formed in the at least a first sidewall panel and is located between the first weakened portion and the fold line between the opposite fold lines which fold line provides for pivotal movement relative to the at least a first sidewall panel. A pour spout is provided and has a central body portion, a first wing portion extending from one side of said central body portion and a second wing portion extending from the other side of said central body portion. The central body portion of the pour spout is united with the second weakened portion for movement therewith so that the central body portion and the first and second wing portions cooperate to form a pour spout. The carton blank also has an inner layer comprising a generally rectangular sheet of a relatively flexible fluid impervious material. At least portions of the inner layer are secured to at least portions of the outer layer and at least other portions of the inner layer are secured to at least portions of the central body portion of the pour spout.

The pour spout has an outer surface and an inner surface with at least portions of the outer surface of the central body portion being secured to at least portions of the second weakened portion with the first wing portion being superposed over but not secured to the second sidewall panel and the second wing portion being superposed over but not secured to the third sidewall panel. At least portions of the inner surface of the central body portion are secured to at least portions of the inner layer. The first wing portion is joined to the central body portion by a fold line and the second wing portion is joined to the central body portion by a fold line.

A third weakened portion, is formed in a portion of the inner layer and comprises a plurality of cut lines. Continuous portions of the inner layer on either side of each of the cut lines are secured to portions of the central body portion of the pour spout to retain the fluid imperviousness of the inner layer. At least portions of the first and second weakened portions are in a coinciding relationship and at least one of the plurality of cut lines of the third weakened portion is parallel to but spaced from the at least portions in the coinciding relationship.

A second one of the plurality of cut lines of the third weakened portion is parallel to but spaced from the fold line joining the central body portion and the first wing portion of the pour spout and a third one of the plurality of cut lines of the third weakened portion is parallel to but spaced from the fold line joining the central body portion and the second wing portion of the pour spout.

In another preferred embodiment of the invention, the conventional panels comprise at least a plurality of top panels joined by fold lines to adjacent sidewall panels, a front panel and a back panel. At least one continuous strip of a relatively flexible material is superposed at least over the top panels and portions of the opposite sidewall panels the front panel and the back panel adjacent to the fold lines joining the top panels and the opposite sidewall panels, the front panel and the back panel; and at least portions of the continuous strip of a relatively flexible material is secured to at least portions of the inner layer.

A carton formed from the above-described carton blank comprises an outer layer formed from a relatively rigid material and has at least first, second and third sidewall panels wherein one of the fold lines joins the first sidewall panel to a top panel. A first weakened portion is formed in the first sidewall panel adjacent to such fold line. A second weakened portion is formed in the first sidewall panel and is located so that at least a portion of the second weakened portion coincides with at least a portion of the first weakened portion. A pour spout is provided and has a central body portion, a first wing portion extending from one side of the central body portion and a second wing portion extending from the other side of the central body portion. The central body portion of the pour spout is secured to the second weakened portion with the first wing portion superposed over but not secured to at least a portion of the second sidewall panel and the second wing portion superposed over but not secured to at least a portion of the third sidewall panel.

An inner layer comprising a generally rectangular sheet of a relatively flexible fluid impervious material has at least portions thereof secured to at least portions of the outer layer and at least other portions of the inner layer secured to at least portions of the central body portion of the pour spout. The first and second wing portions are located between but not secured to the outer and inner layers and are mounted for movement relative thereto.

### BRIEF DESCRIPTION OF THE DRAWINGS

Various embodiments of the invention are illustrated in the drawing in which:

FIG. 1 is a top plan view of a carton blank of this invention;

FIG. 2 is a perspective view of a carton formed from the carton blank of FIG. 1 in an opened position;

FIG. 3 is a cross-sectional view taken on the line 3-3 of FIG. 1 of one embodiment of the carton blank of this invention;

FIG. 4 is a cross-sectional view similar to FIG. 3 of another embodiment of the carton blank of this invention; and

FIG. 5 is a cross-sectional view similar to FIG. 3 of another embodiment of the carton blank of this invention;

FIG. 6. is a partial top plan view of another embodiment of a carton blank of the invention;

FIG. 7 is a top plan end of FIG. 6;

FIG. 8 is a perspective view of a portion of a carton formed from the carton blank of FIG. 6;

FIG. 9 is a partial side elevational view of a portion of FIG. 8 showing the spout partially opened;

FIG. 10 is a schematic illustration of apparatus for use in forming carton blanks of this invention;

FIG. 11 is a top plan view of a portion of the outer surface of the continuous strip of a relatively rigid material having cut and fold lines formed therein;

FIG. 12 is a top plan view of a portion of the inner surface of the carton blank after the continuous sheet of a relatively flexible material and the coating of adhesive has been applied thereto;

FIG. 13 is a top plan view wherein the pour spout has been applied to the illustration in FIG. 12;

FIG. 14 is a top plan view of a portion of the inner surface of a carton blank of this invention;

FIG. 15. is a cross-sectional view taken on the line 15-15 of FIG. 14;

FIG. 16 is a view in cross-section to show the relationship between the wing portions of the pour spout and the outer and inner layers; and

FIG. 17 is a perspective view of a carton of this invention with the pour spout opened.

### DETAILED DESCRIPTION OF THE INVENTION

In FIG. 1, there is illustrated a carton blank 2 having an outer layer comprising a unitary sheet 4 of a relatively rigid material, such as a composite material described in U.S. Pat. No. 4,254,173 to Peer, Jr., which is incorporated herein by reference thereto, a conventional paperboard or other materials having similar characteristics. The unitary sheet 4 is provided with a plurality of fold lines 6 and cut lines 8 to form a front panel 10, a back panel 12, opposite sidewall panels 14 and 16, a glue tab panel 18, top panels 20 and bottom panels 22. The glue tab panel 18 also has a fold line 24. The unitary sheet 4 has a top edge 26, a bottom edge 28, a left side edge 30 and a right side edge 32. It is understood that the unitary sheet may have other configurations.

The unitary sheet 4 is provided with linearly extending weakened portion which as illustrated in FIG. 1 comprises conventional perforated lines 34 in the front panel 10, the back panel 12 and the sidewall panel 16 which also has fold lines 36. Also, perforated lines 38 are formed in two of the top panels 20. All of these perforated lines 34, fold lines 36 and perforated lines 38 function to provide an opening as described below. However, it is understood that other types of conventional opening means may be employed within the concepts of this invention.

The carton blank 2 also has an inner layer comprising a generally rectangular sheet 50, preferably of a fluid impervious material, having a central body portion 52 located between the lines 54 and 56 that is secured to opposite portions of the unitary sheet 4 by a suitable adhesive 58. Portions of the edge portions of the generally rectangular sheet 50 coincide with the top edge 26, the bottom edge 28, the left side edge 30 and the right side edge 32. The generally rectangular sheet 50 has a weakened portion 60, by various means some of which are described below, at least part of which is located opposite to portions of the linearly extending perforated lines 34 for purposes described below. The weakened portion 60 is illustrated in FIG. 1 by a dashed line.

One preferred embodiment of the invention is illustrated in FIG. 3. The generally rectangular sheet 50 comprises a plastic material 70 laminated to a relatively flexible paper material 72 by a suitable adhesive 74. The generally rectangular sheet 50 has a first portion 76 and a second portion 78 having edges 80 and 82 in a face to face relationship which are located to form the weakened portion 60. The plastic material 70 can be a polypropylene material or any other type of material having similar characteristics. The paper material 72 can be formed from Kraft or recycled fibers or any other materials having similar characteristics. The central body portion 52 of the paper material 64 is secured to opposite portions of the unitary sheet 4, illustrated in FIG. 3 as the back panel 12, by a suitable adhesive 58 wherein a portion of the adhesive 58 is located between the side edges 80 and 82 to preserve the integrity of the generally rectangular sheet 50 of a relatively flexible fluid impervious material and to permit separation of the first and second portions 76 and 78 as described below.

Another preferred embodiment of the invention is illustrated in FIG. 4. The generally rectangular sheet 50 comprises a plastic material 70 comprising a first portion 86 and a second portion 88 laminated to the paper material 72, comprising a unitary sheet, by the adhesive 74. The paper material 72 is provided with a series of perforations 90 to provide the weakened portion 60. The adhesive 74 joins the first and second portions 86 and 88 along a continuous line 92 to preserve the integrity of the generally rectangular sheet 50 of a relatively flexible fluid impervious material. The adhesive 74 preferably comprises a hot melt adhesive so, if the outer surface of the plastic material 70 is provided with a heat sealing adhesive, the overlying portions 94 will be sealed together to further ensure the integrity of the generally rectangular sheet 50. However the perforations 90 and the adhesive 74 and the overlying portions 94 permit separation of the generally rectangular sheet 50 along the lines 90 and 92 for purposes described below.

Another preferred embodiment of the invention is illustrated in FIG. 5. The generally rectangular sheet 50 comprises the plastic material 70 comprising a first portion 96 and a second portion 98. The central body portion 52 of the first and second portions 96 and 98 is secured to the unitary sheet 4 by the adhesive 58 which joins the first and second portions 96 and 98 along the continuous line 100 to preserve the integrity of the generally rectangular sheet 50 of a relatively flexible fluid impervious material. Also, the adhesive 58 preferably comprises a hot melt adhesive so, if the outer surface of the plastic material 70 is provided with a heat sealing adhesive, the overlying portions 102 will be sealed together to further ensure the integrity of the generally rectangular sheet 50. However, the continuous line 100 and the overlying portions 102 permit separation of the generally rectangular sheet 50 for purposes described below.

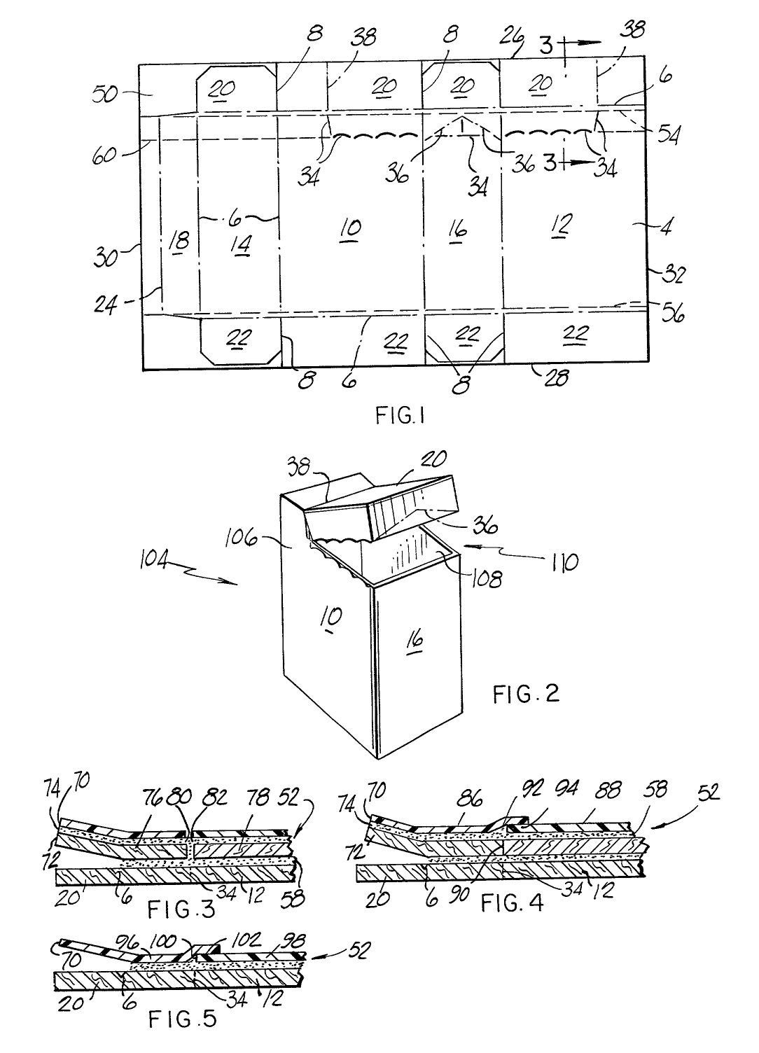

In FIG. 2, there is illustrated an opened carton 104 having an outer layer 106 and an inner layer 108 formed from any of the embodiments of the invention such as those illustrated in FIGS. 3-5. The carton blank 2 is folded around the fold lines 6 and 18 to form an open ended enclosure (not shown). The bottom panels 22 and the corresponding bottom portion of the generally rectangular sheet 50 are folded and sealed together to form a carton having one open end (not shown) which is then filled with the desired material and the top panels 20 and the corresponding top portion of the generally rectangular sheet 50 are folded together and sealed to form the filled carton (not shown). When it is desired to remove the material from the carton, pressure is applied to the portion of the sidewall 16 enclosed by the fold lines 36 and the perforated line 34 and the outer and inner layers 106 and 108 are opened simultaneously along the linearly extending opening means 34 and the weakened portion 60 and folded back along the fold lines 38 to provide an opening 110. The portions of the outer and inner layers 106 and 108 adjacent to the opening 110 are sealed together by the adhesives 58 and 74.

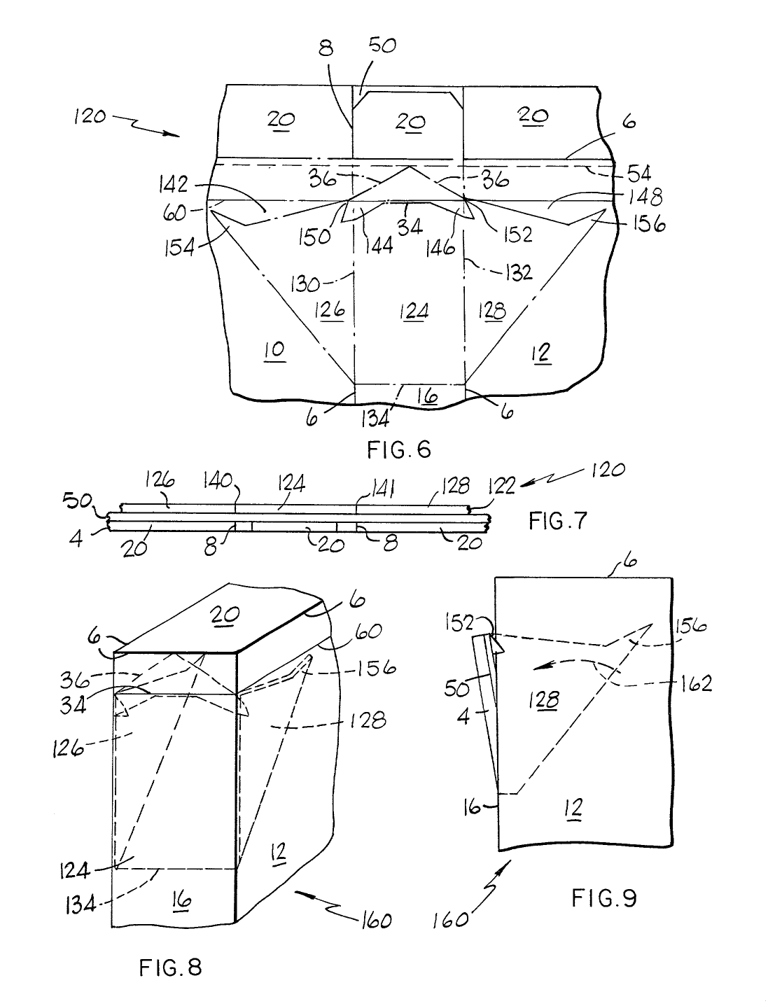

In FIGS. 6-8, there is illustrated another preferred embodiment of the invention for forming a pour spout in a carton. The portions of the invention in FIGS. 6-8 that correspond to portions of the invention in FIGS. 1-5 have been identified with the same reference numerals.

In FIGS. 6 and 7, there is illustrated a portion of another preferred carton blank 120 that comprises a unitary sheet 4 of a relatively rigid material and a generally rectangular sheet 50 of a relatively flexible fluid impervious material, as described above.

A spout forming piece 122 of a relatively rigid material is provided and has a central portion 124 and two wing portions 126 and 128. The spout forming piece 122 is formed from a material such as that described in the Peer, Jr. patent, a conventional paperboard or a relatively rigid plastic material, such as polypropylene or polyester. Perforated lines 130 and 132 form opposite side edges for the sidewall panel 16 in a portion of the fold lines 6 of the unitary sheet 4 of a relatively rigid material and another fold line 134 is also formed therein. The central portion 124 is secured to that portion of the generally rectangular sheet 50 of a relatively flexible fluid impervious material secured to the portion of sidewall panel 16 between the perforated lines 130 and 132, the weakened portion 34 and the fold line 134.

A fold line 140 connects wing portion 126 to the central portion 124 and a fold line 141 connects wing portion 128 to the central portion 124. Cut out portions 142,144,146 and 148 in the central portion 124 and the wing portions 126 and 128 function to provide sharp, pointed projections 150 and 152 for purposes described below. Stop portions 154 and 156 limit the outward movement of the wing portions 126 and 128. The wing portions 126 and 128 are not secured to any other portion of the carton blank 120.

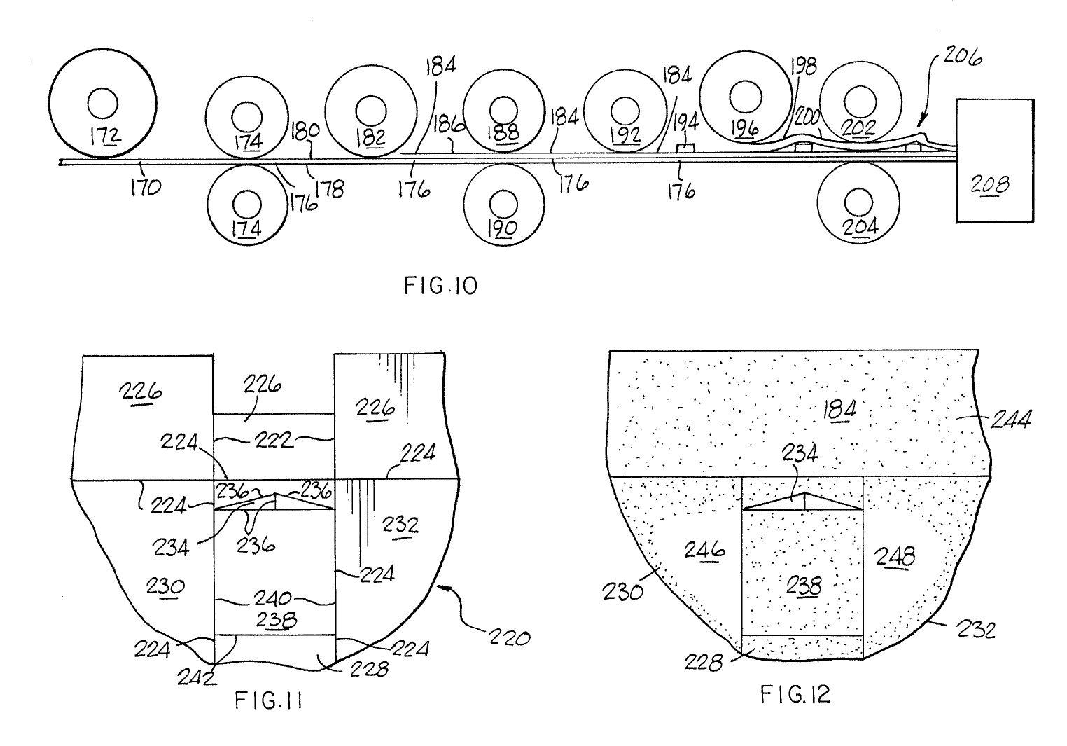

The operation of a carton 160 formed from the carton blank 120 is illustrated in FIGS. 8 and 9. In FIG. 8, the carton blank has been folded to form the carton 160 which has been filled with a desired product and sealed. The wing portions 126 and 128 are adjacent to portions of the front 10 and back 12 panels. When it is desired to remove portions of the product from the carton 160, a finger (not shown) is placed against the portion of the unitary sheet 4 of a relatively rigid material defined by the lines 34 and 36 and sufficient force is applied to move these portions inwardly. This operation breaks the weakened portions 34 and part of 60. The finger is then moved against a portion of the central portion 124 and an outwardly directed force is applied thereto to move the sharp pointed projections 150 and 152 into contact with and to pierce portions of the generally rectangular sheet 50 of a relatively flexible fluid impervious material. The continued outward movement of the central portion 124, as indicated by the arrow 162, also moves the portion of the unitary sheet 4 of a relatively rigid material outwardly breaking the perforations 130 and 132 and pivoting around the fold line 134. The generally rectangular sheet 50 of a relatively flexible fluid impervious material also splits along a line corresponding to the perforations 130 and 132. The wing portions 126 and 128 also move outwardly to provide the side portions of the pour spout in cooperation with the central portion 124.

In FIG. 10, there is a schematic illustration of apparatus for making a preferred embodiment of the carton blank of this invention. A continuous strip 170 of a relatively rigid material, such as that disclosed in the Peer, Jr. patent, conventional paperboard or other materials having similar characteristics, is pulled from a roll 172 of such material and passes between cutting and creasing rolls 174 where substantially all of the cut and fold lines for the carton blanks are made. In a preferred embodiment, the only cut line not made is the cut line between successive carton blanks. The cut and creased continuous strip 176 has an outer surface 178 and an inner surface 180 and is passed under a plurality rolls 182 from which a plurality of continuous strips 184 of a relatively flexible material, such as a Kraft paper or other materials having similar characteristics, are superposed in a spaced apart relationship over the cut and creased continuous strip 176. The continuous strips 184 have an outer surface (not shown) facing the inner surface 180 and an inner surface 186 and leave portions of the cut and creased continuous strip 176 exposed. The cut and creased continuous strip 176 and the plurality of continuous strips 184 pass through hot melt adhesive applying rolls 188 and 190 whereat a conventional hot melt adhesive at temperatures between about 350° F. and 400° F. is applied to at least portions of the inner surface 186 of the continuous strips 184 and to at least portions of the exposed portions of the inner surface 180 of the cut and creased continuous strip 176. The adhesive coated cut and creased continuous strip 176 and the adhesive coated continuous strips 184 pass beneath a roll 192 which deposits a pour spout 194, described move fully below, over a portion of the adhesive coated continuous strip 176. The adhesive coated cut and creased continuous strip 176, the continuous strips 184 and the pour spout 194 pass beneath a roll 196 from which a continuous strip 198 of a relatively flexible fluid impervious material, such as a plastic film of a polyethylene material or other plastic materials having similar characteristics or a plastic coated paper material or other materials having similar characteristics, is superposed over the adhesive coated continuous strip 176, the continuous strips 184 and the pour spout 194. In a preferred embodiment of the invention, the continuous strips 170 and 198 have the same width in a cross machine direction and are sufficiently wide so that they can be cut in half to form adjacent carton blanks. The continuous strip 198 has an outer surface (not shown) facing the adhesive coated cut and creased continuous strip 176, the adhesive coated continuous strips 184 and the pour spouts 194 and also an inner surface 200.

All of the above described materials then pass between laminating rolls 202 and 204 to form the laminated product 206 described more fully below. In a preferred embodiment of the invention, the laminating rolls 202 and 204 provide a pulling force to pull the continuous strips 170, 184 and 198 from the rolls 172, 182 and 192. Also, the rolls 174, 188, 190 and 198 may be independently driven to move at the same velocity as the continuous strips 170, 184 and 198 which is preferable between about 300 and 100 feet per minute. The laminated product 206 then moves into processing apparatus 208 wherein a portion of the continuous strip 198 is secured to a portion of the pour spout 194 and the cuts are made to form the individual carton blanks which are then collected.

In FIG. 11, there is illustrated a portion 220 of the cut and creased continuous strip 176 having cut lines 222 and fold lines formed therein to form top panels 226, a first sidewall panel 228, second sidewall panel 230 and third sidewall panel 232. A first weakened portion 234 is formed in the first sidewall panel 228 by a plurality of perforated cut lines 236. A second weakened portion 238 is formed in the first sidewall panel 228 by a plurality of perforated cut lines 240 and one of the perforated cut lines 236. The second weakened portion 238 is pivotally mounted on the first sidewall panel 228 by a fold line 242. The perforated cut lines 240 are extensions of the fold lines 224 forming the first sidewall panel 228 and terminate at the one perforated cut line 236.

In FIG. 12, one of the continuous strips 184 has been superposed over a portion of the inner surface 180 to cover the top panels 226, the fold lines 224 between the top panels 226 and the first, second and third sidewall panels 228, 230 and 232 adjacent to the fold lines 224. Portions of the continuous strip 184, the sidewall panels 228, 230 and 232 and the second weakened portion 238 are coated with the adhesive 244. The first weakened portion 234, the portion 246 of the second sidewall panel 230 and the portion 248 of the third sidewall panel 232 are not coated with the adhesive 244. It is understood that the continuous strip 184 may be omitted to form a carton blank as illustrated in the portion illustrated in FIG. 5 above.

In FIG. 13, a pour spout 194 has been superposed over portions of the first, second and third sidewall panels 228, 230 and 232. The pour spout 194 has a central body portion 250, a first wing portion 252 and a second wing portion 254. A fold line 256 between the central body portion 250 and the first wing portion 252 permits pivotal movement therebetween. A fold line 258 between the central body portion 250 and the second wing portion 254 permits pivotal movement therebetween. The central body portion 250 overlies and is secured to the second weakened portion 238. The first wing portion 252 overlies the non-adhesive coated portion 246 and the second wing portion 254 overlies the non-adhesive coated portion 248. As illustrated in FIG. 15, the pour spout 194 is formed from a lamination of a conventional paperboard 262, preferably formed from bleached Kraft fibers and having a thickness of about 0.015 inch laminated by a suitable adhesive to a film 264 of a polyester material having a thickness of about 0.0005 inch and the exposed surface thereof is coated with a coating layer 266 of a polyethylene material or a material having similar characteristics. In another embodiment, the pour spout 194 is formed from a relatively rigid fluid impervious material such as a polyethylene having a thickness of about 0.012 in or other materials having similar characteristics. Each of the first and second wing portions 246 and 248 has an abutment 260 to limit the outward movement of the pour spout 194.

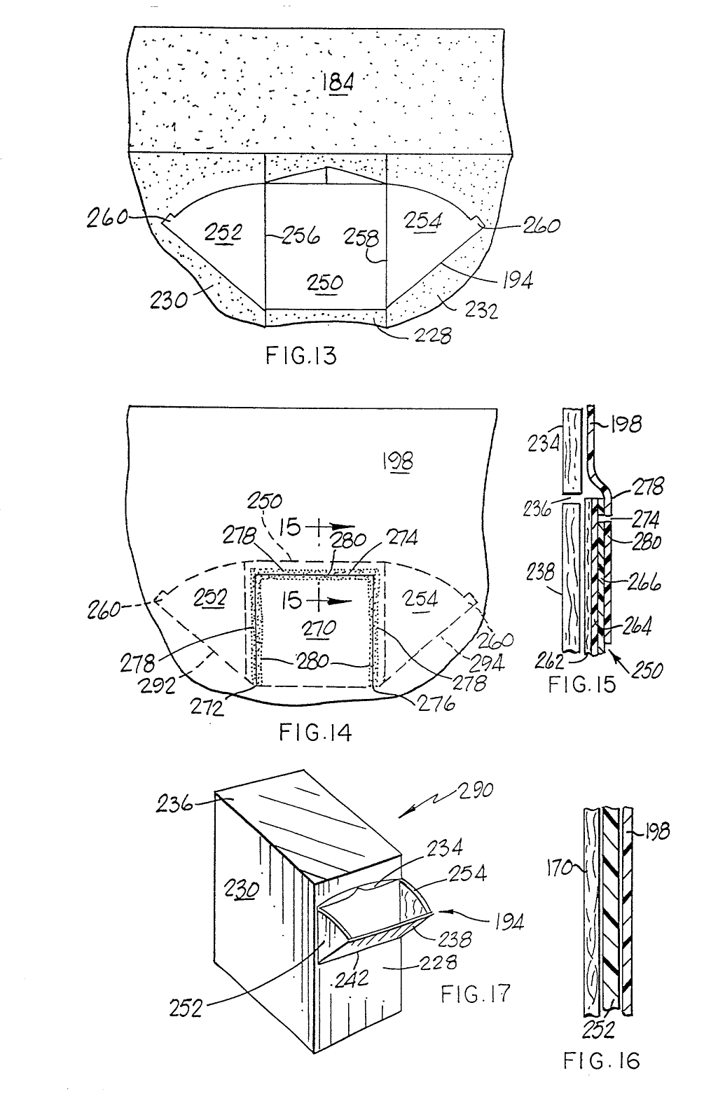

In FIG. 14, the continuous strip 198 of a relatively flexible fluid impervious material is secured to the adhesive coated portions of the continuous strip 184 and the sidewall panels 228, 230 and 232. A third weakened portion 270 is formed in a portion of the continuous strip 198 overlying the central body portion 250 of the pour spout. The third weakened portion 270 is formed by a plurality of, cut lines 272, 274 and 276, which cut lines can be perforated lines, which are continuous and wherein one end of the cut line 272 intersects with one end of the cut line 274 and one end of the cut line 276 intersects with the other end of the cut line 274 and are formed by a heated cutting apparatus (not shown) so that, as the cut lines 272, 274 and 276 are made, a continuous portion 278 of the continuous strip 198 on one side of the cut lines 272, 274 and 276 is secured to the underlying portions of the coating layer 266 of the central body portion 250 of the pour spout and another continuous portion 280 on the other side of the cut lines 272, 274 and 276 is secured to the underlying portions of the central body portion 250 of the pour spout. This preserves the integrity of the continuous strip 198 of a relatively flexible fluid impervious material. In another embodiment of the invention, a coating of a suitable adhesive material, such as a conventional hot or cold melt adhesive, may be applied to the portions 278 and 280 instead of using the heat from the heated cutting apparatus. When the adhesive coating is applied to the portions 278 and 280 a non-heated cutting apparatus may be used. No portion of the first and second wing portions 252 and 254 is secured to either of the continuous strips 170 and 198, as illustrated in FIG. 16, so that the first and second wing portions 252 and 254 are free to move relative to the continuous strips 170 and 198 but are contained between them. This prevents the first and second wing portions 252 and 254 from being displaced as the carton is filled with the desired material.

The heated cutting apparatus forming the cut lines 272, 274 and 276 and the sealed portions 278 and 280 is set at a temperature capable of performing the above described functions. If the continuous strip 198 of a relatively flexible fluid impervious material is a polyethylene having a melt point of about 290° F., the heated cutting apparatus preferably has a temperature at least as great as 290° F. but preferably higher. The central body portion 250 of the pour spout is particularly suited for this operation. The coated layer 266 of a polyethylene material is compatible to the continuous strip 198 of a relatively flexible fluid impervious material so that the heated cutting apparatus will cut through the two polyethylene layers and seal together the two polyethylene layers at the portions 278 and 280. The film 264 of a polyester material has a higher melt point so that, as the heated cutting apparatus makes the cut lines 272, 274 and 276 and the sealed together portions 278 and 280, it does not melt through the film 264 of the polyester material to preserve the integrity of the fluid impervious lining.

A carton 290 formed from a carton blank described above is illustrated in FIG. 17 with the pour spout 194 in the opened position. The pour spout 194 is moved to the opened position by placing a finger tip (not shown) against the first weakened portion 234 and pushing inwardly. As the first weakened portion 234 moves inwardly the seal 278 between the continuous strip 198 and the central body portion 250 adjacent to the first weakened portion 234 is broken to allow the first weakened portion 234 to move inwardly. After the first weakened portion 234 has been moved inwardly a sufficient distance, the finger tip is placed against the portion 280 of the continuous strip 198 secured to the central body portion 250 and an outwardly directed force is applied thereto. This moves the central body portion 250 and the second weakened portion 238 outwardly and gradually breaks the seal between the continuous portion 278 and the central body portion 250 to allow the first and second wing portions 252 and 254 to be moved outwardly. The abutments 260 limit the outer movement of the first and second wing portions 252 and 254. After the desired amount of material has been removed from the carton 290, an inwardly directed force is applied to the pour spout 194. The inward movement of the first and second wing portions 252 and 254 is limited by the secured together portions 292 and 294 of the continuous strips 170 and 198.

It is contemplated that the inventive concepts herein described may be variously otherwise embodied and it is intended that the appended claims be construed to include alternative embodiments of the invention except insofar as limited by the prior art.

What is claimed:

1. A carton blank comprising:
an outer layer comprising a generally rectangular sheet of a relatively rigid material;
said outer layer having a plurality of cut and fold lines formed therein for dividing said outer layer into a plurality of panels;
said outer layer having at least one top panel integral with at least a first sidewall panel and joined thereto by a fold line;
said at least a first sidewall panel being integral with a second sidewall panel and a third sidewall panel and joined thereto by opposite fold lines;
a first weakened portion formed in said at least a first sidewall panel adjacent to said fold line between said at least one top panel and said at least a first sidewall panel;
a fold line in said at least a first sidewall panel extending between said opposite fold lines and spaced from said first weakened portion;
a second weakened portion formed in said at least a first sidewall panel and located between said first weakened portion and said fold line between said opposite fold lines;
said second weakened portion being mounted for pivotal movement relative to said at least a first sidewall panel;
a pour spout having a central body portion, a first wing portion extending from one side of said central body portion and a second wing portion extending from the other side of said central body portion;
said central body portion of said pour spout being united with said second weakened portion for movement therewith so that said central body portion and said first and second wing portions cooperate to form said pour spout;
an inner layer comprising a generally rectangular sheet of a relatively flexible fluid impervious material; and
at least portions of said inner layer being secured to at least portions of said outer layer and at least other portions of said inner layer being secured to at least portions of said central body portion of said pour spout.

2. A carton blank as in claim 1 wherein:
said pour spout having an outer surface and an inner surface;
at least portions of said outer surface of said central body portion being secured to at least portions of said second weakened portion with said first wing portion being superposed over but not secured to said second sidewall panel and said second wing portion being superposed over but not secured to said third sidewall panel;
at least portions of said inner surface of said central body portion being secured to at least portions of said inner layer; and
said first wing portion being joined to said central body portion by a fold line and said second wing portion being joined to said central body portion by a fold line.

3. A carton blank as in claim 2 and further comprising:
a third weakened portion;
said third weakened portion being formed in a portion of said inner layer;
said third weakened portion comprising a plurality of cut lines;
continuous portions of said inner layer on either side of each of said cut lines being secured to portions of said pour spout to retain the fluid imperviousness of said inner layer.

4. A carton blank as in claim 3 wherein:
at least portions of said first and second weakened portions being in a coinciding relationship; and
at least one of said plurality of cut lines of said third weakened portion being parallel to but spaced from said at least portions in said coinciding relationship.

5. A carton blank as in claim 4 wherein:
a second one of said plurality of cut lines of said third weakened portion being parallel to but spaced from said fold line joining said central body portion and said first wing portion of said pour spout; and
a third one of said plurality of cut lines of said third weakened portion being parallel to but spaced from said fold line joining said central body portion and said second wing portion of said pour spout.

6. A carton blank as in claims 5 wherein:
said continuous portions being secured only to portions of said central body portion of said pour spout; and
said first and second wing portions being located between but not secured to portions of said outer and inner layers.

7. A carton blank as in claim 1 and further comprising:
said plurality of panels comprising at least a plurality of top panels joined by fold lines to adjacent sidewall panels, a front panel and a back panel;
at least one continuous strip of a relatively flexible material superposed at least over said top panels and portions of said opposite sidewall panels said front panel and said back panel adjacent to said fold lines joining said top panels and said opposite sidewall panels; said front panel and said back panel; and
at least portions of said at least one continuous strip of a relatively flexible material being secured only to at least portions of said inner layer.

8. A carton blank as in claim 7 and further comprising:
a third weakened portion;
said third weakened portion being formed in a portion of said inner layer;
said third weakened portion comprising a plurality of cut lines;
continuous portions of said inner layer on either side of each of said cut lines being secured to portions of said pour spout to retain the fluid imperviousness of said inner layer.

9. A carton blank as in claim 8 wherein:
said continuous portions being secured only to portions of said central body portion of said pour spout; and
said first and second wing portions being located between but not secured to portions of said outer and inner layers.

10. A carton blank as in claim 1 and further comprising:
said outer layer having an outer surface and an inner surface;
said inner layer having an outer surface and an inner surface;
said pour spout having an outer surface and an inner surface;
at least portions of said outer surface of said central body portion of said pour spout being secured to at least portions of said inner surface of said second weakened portion for movement therewith; and
a sharp point on each of said first and second wing portions so that when said central body portion of said pour spout moves outwardly said sharp points will penetrate and form openings in said inner layer so that said at least portion of said inner layer secured to said central body portion of said pour spout will tear away from other portions of said inner layer during the formation of said pour spout.

11. A pour spout for a carton wherein the carton has a plurality of sidewall panels and top and bottom panels with a first sidewall panel having a pair of spaced apart fold lines joining the first sidewall panel to a second sidewall panel and a third sidewall panel comprising:
an outer layer formed from a relatively rigid material;
said first sidewall panel having another fold line joining said first sidewall panel to a top panel;
a first weakened portion formed in said first sidewall panel adjacent to said another fold line;
a second weakened portion formed in said first sidewall panel and located so that at least a portion of said second weakened portion coincides with at least a portion of said first weakened portion;
a pour spout having a central body portion, a first wing portion extending from one side of said central body portion and a second wing portion extending from the other side of said central body portion;
said central body portion of said pour spout being secured to said second weakened portion with said first wing portion superposed over but not secured to at least a portion of said second sidewall panel and said second wing portion superposed over but not secured to at least a portion of said third sidewall panel;
a generally rectangular sheet of a relatively flexible fluid impervious material superposed over said outer layer and said pour spout so that said pour spout is located between said outer and inner layers; and
at least portions of said inner layer being secured to at least portions of said outer layer and at least other portions of said inner layer being secured to at least portions of said central body portion of said pour spout.

12. A pour spout for a carton as in claim 11 and further comprising:
said first and second wing portions being located between said outer and inner layers and mounted for movement relative thereto.

13. A pour spout for a carton as in claim 12 and further comprising:
a third weakened portion;
said third weakened portion being formed in a portion of said inner layer;
said third weakened portion comprising a plurality of cut lines;
continuous portions of said inner layer on either side of each of said cut lines being secured to portions of said pour spout to retain the fluid imperviousness of said inner layer.

14. A pour spout for a carton as in claim 13 wherein:
at least portions of said first and second weakened portions being in a coinciding relationship; and
at least one of said plurality of cut lines of said third weakened portion being parallel to but spaced from said at least portions in said coinciding relationship.

15. A pour spout for a carton as in claim 14 wherein:
a second one of said plurality of cut lines of said third weakened portion being parallel to but spaced from said fold line joining said central body portion and said first wing portion of said pour spout; and
a third one of said plurality of cut lines of said third weakened portion being parallel to but spaced from said fold line joining said central body portion and said second wing portion of said pour spout.

16. A pour spout for a carton as in claim 15 wherein:
said continuous portions being secured only to portions of said central body portion of said pour spout.

17. A pour spout for a carton as in claim 13 wherein:
said continuous portions being secured only to portions of said central body portion of said pour spout.

18. A pour spout for a carton as in claim 17 wherein:
said pour spout having an outer surface and an inner surface;
at least portions of said outer surface of said central body portion being secured to at least portions of said second weakened portion with said first wing portion being superposed over, but not secured to said second sidewall panel and said second wing portion being superposed over but not secured to said third sidewall panel;
at least portions of said inner surface of said central body portion being secured to at least portions of said inner layer; and
said first wing portion being joined to said central body portion by a fold line and said second wing portion being joined to said central body portion by a fold line.

19. A pour spout for a carton as in claim 11 and further comprising:
said outer layer having an outer surface and an inner surface,
said inner layer having an outer surface and an inner surface;
said pour spout having an outer surface and an inner surface;
at least portions of said outer surface of said pour spout being secured to at least portions of said inner surface of said second weakened portion for movement therewith;
at least portions of said outer surface of said central body portion of said pour spout being secured to at least portions of said inner surface of said second weakened portion for movement therewith; and
a sharp point on each of said first and second wing portions so that when said central body portion of said pour spout moves outwardly said sharp points will penetrate and form openings in said inner layer so that said at least portion of said inner layer secured to said central body portion of said pour spout will tear away from other portions of said inner layer during the formation of said pour spout.
